(19) United States
(12) Patent Application Publication
(10) Pub. No.: US 2006/0219109 A1
(43) Pub. Date: Oct. 5, 2006

(54) Method of registering different colours in flexography, and flexographic printer comprising a device for implementing said method

(76) Inventor: Felip Ferrer Cadillach, Riudellots de la Selva (ES)

Correspondence Address: RATNERPRESTIA, P O BOX 980, VALLEY FORGE, PA, 19482-0980, US

(21) Appl. No.: 10/549,770

(22) PCT Filed: Mar. 20, 2003
(86) PCT No.: PCT/ES03/00133

§ 371 Date: Sep. 19, 2005

(51) Int. Cl. B41M 1/14

(52) U.S. Cl. 101/211

(57) ABSTRACT

A method of registering various colours in flexography, and a flexographic printer comprising a device for implementing the method are provided. The printer comprises at least one supporting drum with at least first and second printing rollers and an optical sensor, downstream from the rollers. The method comprises consecutively printing first and second marks with the first and second rollers, using the sensor to generate first and second position signals that are representative of the positions of the first and second marks within a printing length and to generate adjustment signals by comparison of the second position signal with the first position signal, taken as reference, or the first and second position signals with a pre-established position signal. The positions of rollers are adjusted based on the adjustment signals.

### FIELD OF THE INVENTION

In general, this invention concerns to a method of registering various colours in flexography, and more specifically, to the use of a chromatic optical sensor to detect the positions of marks printed by various printing rollers and the carrying out of printing roller position adjustments from said detection. This invention also concerns to a flexographic printer with a device for the implementation of said method.

### TECHNICAL BACKGROUND

Flexographic printers use a large number of printing groups to print the various superposed parts of an image onto a sheet material, where the various superposed parts together form the desired complete image. Generally, each of the various parts corresponds to one colour and the superposition of the various parts of the various colours produces a final image with a chromatic richness that is much higher than that of the limited colours of the component parts. The accuracy in the superposition of the cited parts is essential for final image definition. In most printers, the printing of each part is carried out by corresponding engraving configurations existing on the exterior surfaces of respective printing rollers included in the printing groups and consequently, the angular and axial position adjustment between the rollers and in relation to the material to be printed determines the mentioned accuracy in the superposition of the parts. In the state of the art, the term “register” is employed when referring to the accuracy or coincidence of the superposition of the parts.

In flexographic printers fitted with a central drum, where the various printing groups are arranged around a single supporting drum on which a material to be printed is held in place, the register adjustment was initially performed manually by examining the result of a first printing test of all superposed parts. Later, a video system was introduced in order to obtain printing test images of the superposed parts, although the adjustment of the roller positions continued to be carried out manually. An automatic system is currently being employed that comprises printing, by means of each printing roller, a large number of marks in one margin of the material to be printed and registering said marks via a video image capturing system. Using an image processing system, the distances between said marks are determined and the adjustments to be made to the printing rollers angular and axial positions are calculated.

One inconvenience of this present system is that, since all the marks are printed at the same time, it is necessary to perform an initial pre-positioning of all the printing rollers within certain tolerances to prevent the various marks printed by them being superposed, which would hamper reading operations and make it impossible to measure the distances between them. In addition, the distances between the marks could be so large that they could be affected by possible stretching of the material to be printed which, in turn, would affect the roller adjustment accuracy. Moreover, video image acquisition equipment is relatively expensive and requires flame-proofing, which is also costly if it is to be installed close to the printing groups. In order to avoid said protection, the image acquisition equipments are generally placed at the exit of a printing tunnel of the machine, where the volatile substances in the inks have already evaporated. However, this position far from the printing rollers involves a loss of printing time and material to be printed during the register adjustment operation.

One object of this invention is to provide a method and a device for registering various colours in flexography that provides solutions to the previously described inconveniences.

### BRIEF EXPLANATION OF THE INVENTION

The previous object is achieved with this invention by providing a method of registering various colours in flexography, together with a flexographic printer with a device for the implementation of said method.

The flexographic printer of this invention is of the type that comprises at least one rotating supporting drum that supports a material to be printed, at least first and second printing groups that include respective first and second printing rollers, which have a known printing length. The mentioned first and second printing groups are configured, arranged and selectively driven to change between a printing position, in which a corresponding first and/or second printing roller is in contact with said material to be printed on the cited supporting drum, and an inactive position, in which said corresponding first and/or second roller is separated from the material to be printed. The first and second printing rollers are driven by at least one driving group controlled by at least one controller. The printer of this invention is characterised in that it comprises an optical sensor placed downstream from the first and second printing groups and arranged to detect at least first and second separated marks, respectively and consecutively printed by the first and second printing rollers on the material to be printed. Although not essential, it would be an advantage that the cited optical sensor be a chromatic optical sensor capable of equally detecting marks in any colour, with the possibility of adjusting the detection chromatic level.

The mentioned controller is designed and connected in order to implement the method of this invention based on the readings from said optical detector. There can be a single common controller for all printing groups or each printing group can have its own controller in communication with the others and, for the purpose of this description, the term “controller” will be employed to refer to both cases.

The flexographic printer of this invention may include, in addition to the previously mentioned first and second printing groups, further printing groups placed upstream from said optical sensor. These cited further printing groups include respective printing rollers with said known printing length and which are driven by said at least one driving group regulated by the cited controller. These further printing groups are configured, arranged and selectively driven in order to change between said printing and inactive positions in a similar fashion to the first and second printing groups.

The method of this invention, which is implemented by means of the previously described flexographic printer, comprises two execution modes to carry out the necessary adjustments for the registering of the various colours from the readings made by said optical sensor of marks printed by the printing rollers.

In accordance with one of said execution modes, in first place, the method comprises placing the first printing group at the cited printing position, while the second printing group is maintained in said inactive position, and printing at least a first mark on the material to be printed using the first printing roller of the first printing group. The optical sensor then detects the position of the first mark on the material to be printed and generates a first position signal representative of the longitudinal and transversal position of the first mark within said printing length. Then, the controller generates a first adjustment signal in function of comparing the first position signal with a pre-established position signal. Based on said first adjustment signal, the driving group adjusts the angular and axial positions of the first printing roller. This sequence is then repeated for the second printing group, which is placed at the printing position, while the first printing group is in the inactive position. Then, the second printing roller of the second printing group prints at least a second mark, separated from the previous first mark on the material to be printed. The second mark is then detected by the optical sensor, which generates a second position signal representative of the longitudinal and transversal positions of the second mark in the printing length, this second position mark is compared, by the controller, with the cited pre-established angular and axial position signal in order to generate the second adjustment signal, which is employed by the driving group to adjust the angular and axial positions of the second printing roller. In the case where the flexographic printer includes further printing groups, the routine of comparing the further position signal from the detection of each further mark with the common pre-established position signal is successively repeated and the corresponding adjustment is made, while the other printing groups remain in the inactive position.

In accordance with another execution mode of the invention method, the first step includes, in a similar fashion to the previous execution mode, placing the first printing group in the printing position, while the second printing group remains in the inactive position, and printing a first mark, which is detected by the optical sensor to generate a first position signal representative of the longitudinal and transversal positions of the first mark within the printing length. Then the second printing group is placed in the active position while the first is removed to the inactive position and then the second printing roller prints a second mark that is also read by the optical sensor to generate a second position signal that is representative of the longitudinal and transversal position of said second mark within the printing length. Then the controller produces an adjustment signal in function of a comparison of the second position signal with the first position signal, which is taken as reference and the driving group performs angular and axial positions adjustments of the second printing roller based on said adjustment signal in accordance with the detected position of the first mark within the printing length. In the case where the flexographic printer includes further printing groups, the routine of comparing the further position signal corresponding to the mark printed by each one, with the first position signal taken as reference, is successively repeated and the corresponding adjustment is made, while the other printing groups remain in the inactive position.

Preferably, the first, second and further marks have a triangular shape and each comprises a transversal edge that is perpendicular to a longitudinal lateral edge of the material to be printed, a longitudinal edge parallel to said lateral longitudinal edge of the material to be printed and an oblique edge. Each printing roller simultaneously prints a part of a main printing motif in a central main area of the material to be printed, together with the corresponding mark on a lateral edge of the material to be printed that is free from said main printing motif, so that the mark is clearly visible on a non-printed background of the material to be printed.

The cited longitudinal positions of the respective first, second and further marks within the printing length are determined by performing a reading of a representative signal of the angular position of the first printing roller at the times of the detection of said transversal edge of each of the respective first, second and further marks by the optical sensor. The cited transversal positions of the respective first, second and further marks within said printing length are determined from a difference between the readings of representative signals of the first printing roller angular position at the times of the detection of the transversal and oblique edges, respectively, or vice versa, of each of the respective first, second and further marks by the optical sensor or, which is the same, from the lengths of the paths between the transversal and oblique edges of the respective first, second and further marks detected at the optical sensor reading line.

It should be stressed that, in the flexographic printer, the rotational movements of all the printing rollers are synchronised together and in accordance with the rotational movement of the supporting drum by some of the various systems that are well-known in the current state of the art. Therefore, the mentioned signals representative of the first printing roller angular position can be obtained from at least three alternative sources, depending on the flexographic printer configuration. When each printing group includes its own printing roller driving group driven by an angular position control signal with respect to time, in other words, a set point signal, supplied in common to all driving groups for synchronised rotation, the signals representative of the first roller angular position may be directly obtained from the reading of said set point signal. If each printing group, or at least the first printing group, includes at least one angular position detector associated to the printing roller, the representative signals for the first roller angular position may be directly obtained from first roller angular position detector reading. When there is a single driving group fitted with one or more mechanical transmissions to synchronisely rotate a single supporting drum with all the associated printing rollers, the representative signals of the first roller angular position can be obtained from the reading of the angular position detector associated with the supporting drum or any of the printing rollers or other device of said driving group and associated transmissions.

In the case of employing the first printing roller angular position detector signal as reference for the adjustment of the other printing rollers, the first printing roller is maintained rotating at a print rotation speed, while the first printing group is in the inactive position and said comparison of the subsequent position signals is performed with the first position signal in order not to lose the cited reference.

Thus, the method and device employed in this invention allow the register adjustment of various colours in flexography in a more economical manner than with currently known methods, because only the inclusion of an optical sensor is required, which is significantly more economical than video image acquisition equipments employed up to now, and takes advantage of the angular position detectors and control devices currently existing in many flexographic printers. Moreover, the method of this invention allows the register adjustment operations to be carried out in less time and with less waste of material to be printed since the optical sensor can be placed next to the printing zone, for example, next to the printing group placed furthest downstream. It also has the advantage of not requiring any specific angular pre-positioning of the printing rollers because the marks are printed and read individually and the adjustment operations are accurately performed whatever the initial degree of angular misadjustment. In addition, since the distance between marks is not taken into account, but instead, the position of each mark within the printing length, there is practically no loss of precision due to print material stretching, which is usual in state of the art devices.

### BRIEF DESCRIPTION OF THE DRAWINGS

The previous and other characteristics and advantages can be better understood from the following detailed description of some embodiments of the invention with reference to the included drawings, in which:

FIG. 1 is a sectioned, schematic, side elevation view of a flexographic printer in accordance with this invention in an operational situation;

FIG. 2 is a schematic plan view of a portion of printed material showing the result of an out-of-register printing;

FIG. 3 is a sectioned, schematic side elevation view of the flexographic printer shown in FIG. 1 in a situation of implementing some steps of the method in accordance with this invention;

FIG. 4 is a schematic plan view of a portion of printed material showing the result of a printing corresponding to said steps;

FIG. 5 is a sectioned, schematic side elevation view of the flexographic printer shown in FIG. 1 in a situation of implementing subsequent steps of the method in accordance with this invention;

FIG. 6 is a schematic plan view of a portion of printed material showing the result of a printing corresponding to the mentioned subsequent steps; and

FIG. 7 is a schematic, elevation profile view of the flexographic printer shown in FIG. 1, showing a connection scheme for the implementation of the method in accordance with this invention.

### DETAILED EMBODIMENT DESCRIPTIONS

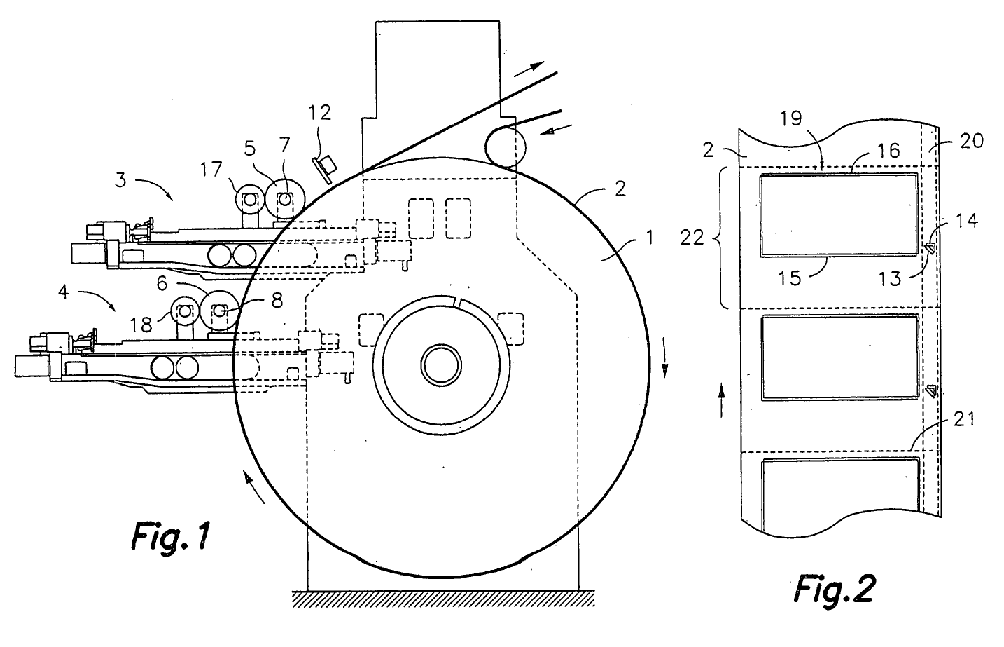

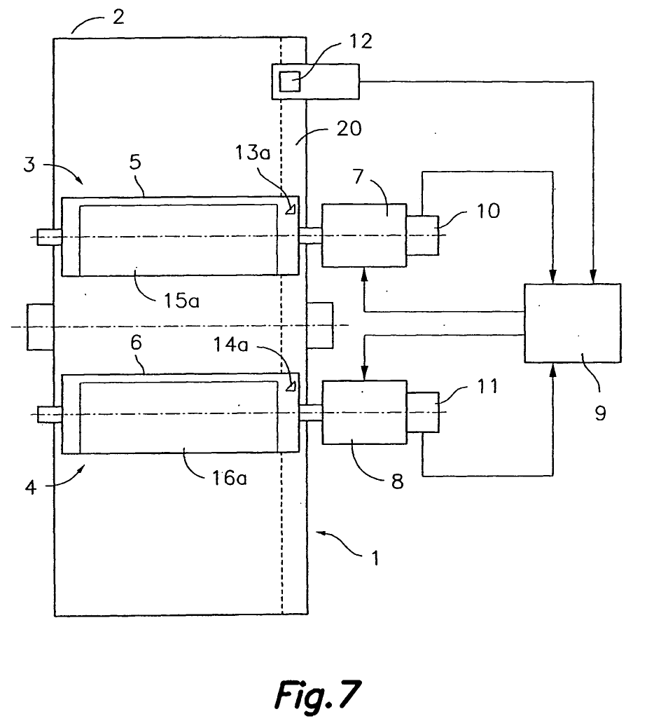

First referring to FIG. 1, it shows a flexographic printer of the type consisting of a central rotating supporting drum 1, supporting the material to be printed 2 in the form of a continuous strip that moves in the direction indicated by the arrows next to the peripheral surface of the drum 2 as it rotates. Next to the supporting drum 2 are the first and second printing groups 3, 4, which include the respective first and second printing rollers 5, 6 and respective first and second ink rollers 17, 18. A printing configuration 15a, 16a (FIG. 7) is arranged at the periphery of each printing roller 5, 6, which constitutes the matrix or stencil of part of the motif to be printed. The cited first and second printing groups 3, 4 are configured, arranged and selectively driven to change between a printing position, in which the corresponding first and/or second printing rollers 5, 6 and consequently, the corresponding printing configuration, is in contact with said material to be printed 2 on the cited supporting drum 1, and an inactive position, in which the corresponding first and/or second printing roller 5, 6 is separated from the material to be printed 2. In the printing position, the ink roller 17, 18 is in contact with the respective printing roller 5, 6 in order to continuously deposit a layer of ink on the corresponding printing configuration.

Now briefly referring to FIG. 7, the first and second printing rollers 5, 6 are respectively driven by first and second driving groups 7, 8 that are regulated by at least one controller 9 in connection with first and second angular position detectors 10, 11 associated with each first and second printing rollers 5, 6. FIG. 7 shows very schematically each driving group 7, 8 as a rotating driving motor, such as an electric motor, for rotating the corresponding printing roller 5, 6. However, each driving group 7, 8 also includes at least one axial movement driving motor (not shown) for the linear movement of the associated printing roller 5, 6 in its axial direction, with said axial movement motor also regulated by said controller 9, optionally in connection with a respective angular position detector.

Returning to FIG. 1, the flexographic printer of this invention comprises an optical sensor 12, placed downstream from the first and second printing groups 3, 4 and arranged to detect at least first and second separated marks 13, 14, printed respectively and consecutively by the first and second printing rollers 5, 6 on the material to be printed 2. The printing configuration 15a, 16a present on each printing roller 5, 6 constitutes a part 15, 16 of an image, and the ink applied by each ink roller 17, 18 is of a different colour. The optical sensor 12 is a chromatic optical sensor capable of detecting a mark whatever its colour, distinguishing it from a uniform background colour of the material to be printed 2. When the printer is in production operation (FIG. 1), both first and second printing groups 3, 4 are in the printing position and the different parts 15, 16 are printed onto the material to be printed 2 so that they are mutually superposed, producing the complete desired image 19.

FIG. 2 shows a portion of the material to be printed 2 on a main central area of which is repeatedly printed superposed some first and second parts 15, 16 of the complete image 19 respectively corresponding to the printing configurations 15a, 16a (see FIG. 7) of the main motif existing on the first and second printing rollers 5, 6. The limits of a printing length 22 of the first and second printing rollers 5, 6 are shown by dotted transversal lines 21. The mentioned printing length 22 is of a known length that is equal for all printing rollers and coincident on the material to be printed 2. First and second marks 13, 14 are placed in a side margin 20 (indicated by trace lines) of the material to be printed 2, which is free of the main printed motif 15, 16, 19, and which have been respectively printed by the first and second printing rollers 5,6 simultaneously with the first and second parts 15, 16 of the image 19. The first and second printing rollers 5, 6 comprise some corresponding engraving configurations 13a, 14a included in the stencil for printing said first and second marks 13, 14 in the margin 20 of the material to be printed 2 next to said main engraving configurations 15a, 16a.

According to FIG. 2, the complete image 19 printed in said main central zone of the material to be printed 2 is confuse, because the first and second parts 15, 16 are out of register, in other words, they are not exactly superposed. This occurs, in spite of the fact that the printing length of all the rollers coincides, almost inevitably at the beginning of printing due to the lack of precision in the axial location of the shirts or print sections on the rollers and that the registering method of this invention does not require any pre-positioning or location of the printing rollers in a pre-established angular position in their respective printing groups. The method of this invention includes a brief steps protocol intended to be carried out automatically for the registering between the parts of the image printed by the various printing rollers, in other words, between the various colours, before production printing commences.

For this reason, the optical sensor 12 of the flexographic printer of this invention is placed in a suitable position to scan the cited side margin 20 of the material to be printed 2 in order to detect the first and second marks 13, 14, and the controller 9 is designed and connected to command the necessary adjustments to the first and second driving groups 7, 8 of the first and second printing rollers 5, 6 from the processing of position signals coming from the optical sensor 12.

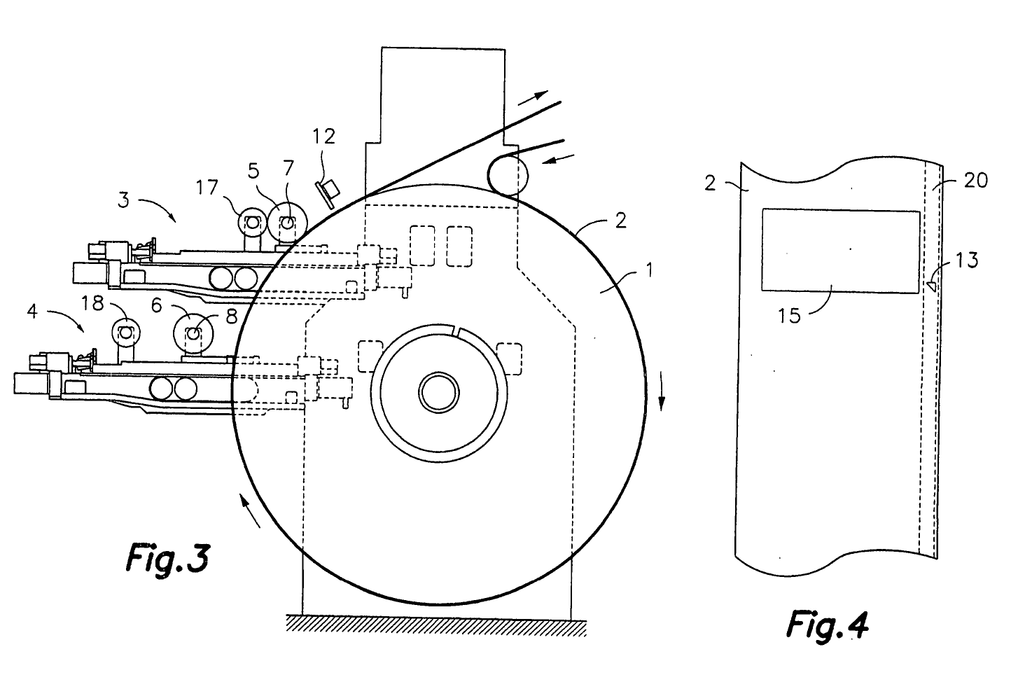

The registering method for the various colours in flexography implemented by the previously described flexographic printer comprises, in first place, placing the first printing group 3 in said printing position and the second printing group 4 in said inactive position, just as shown in FIG. 3, and then printing with the first printing roller 5 of the first printing group 3 a first mark 13 in the side margin 20 of the material to be printed 2, in accordance with the sample shown in FIG. 4. The cited first mark 13 is printed together with the first part 15 of the main motif 19, although this first part 15 does not play any role in the registering method.

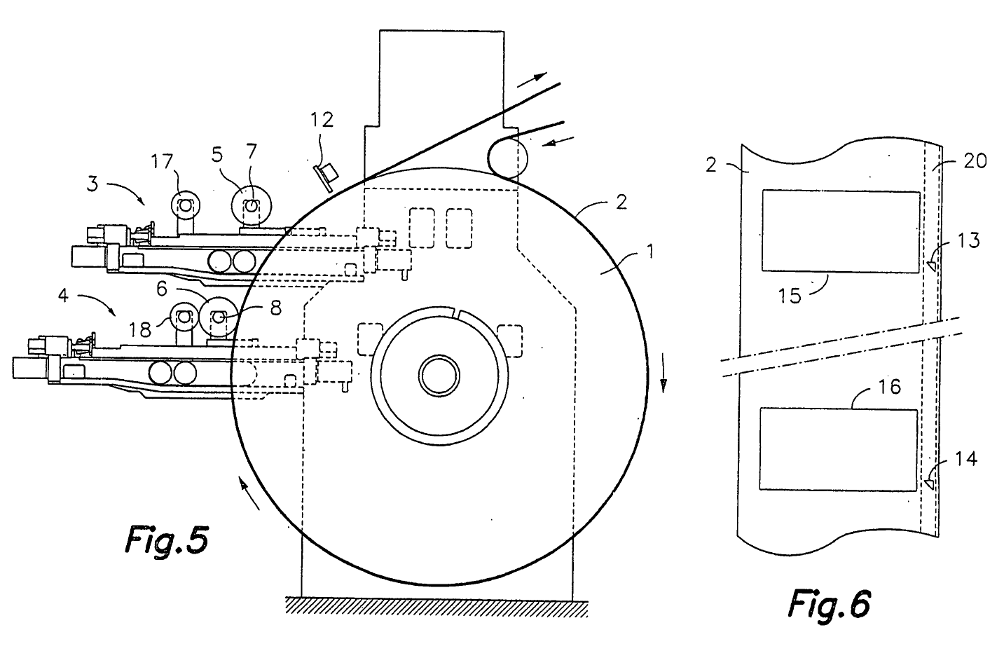

Then, the method comprises placing the second printing group 4 in said printing position and the first printing group 3 in the inactive position, just as shown in FIG. 5, and printing with the second printing roller 6 of the second printing group 4 a second mark 14 in the side margin 20 of the material to be printed 2, together with the second part 16 of the main motif 19. This then guarantees that the second mark 14 is separated from said first mark 12, as shown in FIG. 6.

Thus, the method uses optical sensor 12 to detect the positions of said first and/or second marks 13, 14 on the material to be printed 2. The optical sensor 12 generates first and second position signals that are representative of the longitudinal and transversal positions of said first and second marks 13, 14 within the printing length 22. This is equivalent to detecting the angular and axial positions of the respective engraving configurations 13a, 14a on the respective first and second printing rollers 5, 6 in relation to initial angular and axial positions, in other words, at a “zero angle” of the respective first and second printing rollers 5, 6. The registering adjustment is carried out from the mentioned position signals just as described below. In general, the optical sensor is placed as close as possible to the first printing group 3, which is preferably in the furthest downstream position, and the detection reading of each mark is performed immediately after its printing and before the printing of the next.

Although in the illustrated example, the flexographic printer only includes first and second printing groups 3, 4, said flexographic printer could include, which is quite usual, further printing groups (not shown) placed upstream from said optical sensor 12. Of course, each further printing group includes a corresponding printing roller, an ink roller and a driving group controlled by the controller 9 in connection with at least one angular position detector and optionally at least one axial position detector associated with the roller driving group. Each further printing group is configured, arranged and selectively driven to change between said printing and inactive positions. In this case, the method comprises sequentially placing each further printing group in said printing position maintaining the other printing groups in the inactive position, and printing further separated marks on the material to be printed 2 by the printing rollers of the further printing groups. Then, employing the optical sensor 12 to detect the positions of said further marks on the material to be printed 2, and generating further position signals representative of the longitudinal and transversal positions of the respective further marks within the printing length 22.

The first, second and further marks 13, 14 have a triangular shape and each comprises a transversal edge that is perpendicular to a longitudinal lateral edge of the material to be printed 2, a longitudinal edge parallel to said lateral longitudinal edge of the material to be printed 2 and an oblique edge. In the illustrated example, said transversal edge is the front edge, said longitudinal edge is adjacent to the longitudinal lateral edge of the material to be printed 2 and said oblique edge is the rear edge, although the marks could equally be arranged in any of the other three possible positions. The cited longitudinal positions of the respective first, second and further marks 13, 14 within said printing length are determined from respective angular position signal readings from said first angular position detector 10 of the first printing roller 5 at the times of detection of said transversal edge of each of the respective first, second and further marks 13, 14 by the optical sensor 12, while the cited transversal positions of the respective first, second and further marks 13, 14 within said printing length are determined from a difference between the readings of angular position signals from the first angular position detector 10, 11 of the first printing roller 5 at the times of detecting the transversal and oblique edges, respectively, or vice versa of each of the first, second and further marks 13, 14 by the optical sensor 12.

Alternatively, in the case where the first, second and further driving groups 7, 8 are driven by means of an angular position control signal with respect to the time common to all of them, or set point signal, the cited longitudinal positions of the respective first, second and further marks 13, 14 within said printing length could be determined from a reading of said set point signal at the time of detecting said transversal edge of each of the respective first, second and further marks 13, 14 by the optical sensor 12, while the cited transversal positions of the respective first, second and further marks 13, 14 within said printing length could be determined from a difference between readings of said set point signals at the time of detecting the transversal and oblique edges, respectively, or vice versa, depending on the positions of the marks of each of the respective first, second and further marks 13, 14 by the optical sensor 12.

There is the possibility that the flexographic printer first, second and further printing rollers 5, 6, together with the supporting drum 1 are rotationally driven by a single common driving group with an angular position detector associated with, for example, the supporting drum 1. In this case, the cited longitudinal positions of the respective first, second and further marks 13, 14 within said printing length could be determined from respective angular position signal readings from said first angular position detector of the supporting drum 1 at the times of detection of said transversal edge of each of the respective first, second and further marks 13, 14 by the optical sensor 12, while the cited transversal positions of the respective first, second and further marks 13, 14 within said printing length would be determined from a difference between readings of angular position signals from said angular position detector of the supporting drum 1 at the times of detecting the transversal and oblique edges, respectively, or vice versa, of each of the first, second and further marks 13, 14 by the optical sensor 12.

The method of this invention contemplates to alternative execution modes from the mentioned first, second and further position signals. In accordance with one of these execution modes, the method comprises using said controller 9 to generate adjustment signals in function of a comparison between the second and further position signals and the first position signal, which is taken as reference, and then employing the corresponding driving groups 8 to adjust the angular and axial positions of the second and further printing rollers 6 based on said adjustment signals. In this case, the second and further printing groups are adjusted in accordance with the “real” detected first mark 13 position within the printing length 22, which is the equivalent of the first engraving configuration position 13a on the first printing roller 5.

In accordance with another alternative execution mode, the method comprises using the controller 9 to generate first, second and further adjustment signals in function of a comparison of the first, second and further position signals with a pre-established position signal that is common to all printing rollers and then, based on said first, second and further adjustment signals, adjust the angular and axial positions of the first, second and further printing rollers 5, 6 by means of the corresponding driving groups 7, 8. In this embodiment, all printing groups are adjusted in accordance with a desired pre-established position which, for example, could angularly correspond to the “zero angle” position, or any other desired position, with the results, for all practical purposes, being identical to the result of applying the method's first execution mode.

In the case of using the angular detector position reading of the first printing roller 5 as reference signal, the first printing roller 5 is maintained rotating at a printing rotating speed when the same is placed in said inactive position after having detected the corresponding first mark 13 position in order not to lose the reference or the adjustment to the reference.

FIG. 7 shows the connections from the optical sensor 12 and from the angular position detectors 10, 11 of the first and second printing rollers 5, 6 to the controller 9, and from the controller 9 to the driving groups 7, 8 of the first and second printing rollers 5, 6. Although FIG. 7 shows a single controller 9, which is common to all printing groups, each printing group could have its own controller in communication with the others or, said in a different way, the controller 9 could be divided into several sections dedicated to the various printing groups.

A person skilled in the art would be able to introduce multiple variations to the described and illustrated embodiments without departing from the scope of this invention, as defined in the attached claims. For example, instead of a single central supporting drum as shown in the figures, the flexographic printer could comprise several printing groups in line, with a supporting drum or roller for each printing roller.

1. A method of registering various colours in flexography, implemented by means of a flexographic printer of the type that comprises at least one rotating supporting drum, which supports the material to be printed, and at least first and second printing groups which include some respective printing rollers with the same known printing length, with said first and second printing groups configured, arranged and selectively driven to change between a printing position, in which said first and/or second printing roller are in contact with said material to be printed on the cited supporting drum, and an inactive position, in which the first and/or second printing roller are separated from the material to be printed, and where the first and second printing rollers are driven by at least one driving group regulated by at least one controller comprising:
a) placing the first printing group at said printing position and the second printing group at said inactive position and print at least one first mark on the material to be printed by means of the first printing roller of the first printing group;
b) detecting, by means of an optical sensor, located downstream from the first and second printing groups, the position of said first mark on the material to be printed, and generating a first position signal representative of the longitudinal and transversal positions of the first mark within said printing length;
c) placing the first printing group at said inactive position and the second printing group at said printing position and print at least one second mark, separated from said first mark, on the material to be printed by means of the second printing roller of the second printing group;
d) detecting, by means of said optical sensor, the position of said second mark on the material to be printed and generating a second position signal representative of the longitudinal and transversal positions of the second mark within said printing length; and one of:
e1) generating, by means of said controller, first and second adjustment signals in function of a comparison between each of said first and second position signals and a pre-established position signal; and
f1) adjusting, by means of said at least one driving group, the angular and axial positions of the first and second printing rollers based on said first and second adjustment signals; or
e2) generating, by means of said controller, an adjustment signal in function of a comparison between the second position signal and the first position signal, which is taken as reference; and
f2) adjusting, by means of said at least one driving group, the angular and axial positions of the second printing roller based on said adjustment signal in accordance with the detected position of the first mark within said printing length.

2. A method in accordance with claim 1, wherein said flexographic printer includes further printing groups placed upstream from said optical sensor configured, arranged and selectively driven in order to change between said printing and inactive positions, with said further printing groups having respective printing rollers with the cited known printing length, driven by at least one driving group controlled by said at least one controller, with the method also comprising:
g) sequentially placing each further printing group in said printing position maintaining the other first, second and further printing groups in the inactive position, and printing further separated marks on the material to be printed (2) by the printing rollers of the further printing groups;
h) sequentially detecting, by means of said optical sensor, the positions of said further marks on the material to be printed, and generating further position signals representative of the longitudinal and transversal positions of the respective further marks within said printing length; and one of:
i1) generating, by means of said controller, further adjustment signals in function of a comparison between each of said further position signals and the mentioned pre-established position signal; and
i2) adjusting, by means of the corresponding driving groups, the angular and axial positions of the further printing rollers based on said further adjustment signals; or
j1) generating, by means of said controller, further adjustment signals in function of a comparison between each of said further position signals and the first position signal, which is taken as reference; and
j2) adjusting, by means of the corresponding driving groups, the angular and axial positions of each further printing roller based on said further adjustment signals in accordance with the detected position of the first mark within said printing length.

3. A method in accordance with claim 2, wherein the first, second and further marks have a triangular shape and comprise a transversal edge that is perpendicular to a longitudinal lateral edge of the material to be printed, a longitudinal edge parallel to said lateral longitudinal edge of the material to be printed and an oblique edge.

4. A method in accordance with claim 3, wherein the first, second and further printing rollers of the flexographic printer are driven by respective first, second and further driving groups and are associated with respective first, second and further angular position detectors, and further comprising:
determining the cited longitudinal positions of the respective first, second and further marks within said printing length from respective readings of angular position signals coming from the first angular position detector of the first printing roller at the times of detecting a front edge, constituted either by said transversal edge or by said oblique edge, of each of the respective first, second and further marks by the optical sensor; and
determining the cited transversal positions of the respective first, second and further marks within said printing length from a difference between readings of angular position signals coming from the first angular position detector of the first printing roller at the times of detecting the transversal or oblique edges, respectively, or vice versa, of each of the respective first, second and further marks by the optical sensor.

5. A method in accordance with claim 3 wherein the first, second and further printing rollers of the flexographic printer are driven by respective first, second and further driving groups driven by an angular position control signal with respect to time common to all of them, or set point signal, and further comprising:
determining, the cited longitudinal positions of the respective first, second and further marks within said printing length from a reading of said set point signal at the time of detecting a front edge, whether said transversal edge or said oblique edge, of each of the respective first, second and further marks by the optical sensor; and
determining, the cited transversal positions of the respective first, second and further marks within said printing length from a difference between readings of said set point signal at the times of detecting the transversal and oblique edges respectively, or vice versa, of each of the respective first, second and further marks by the optical sensor.

6. A method in accordance with claim 3, wherein the first, second and further printing rollers and the supporting drum of the flexographic printer are rotationally driven by a single common driving group and the supporting drum, or any of the printing rollers or other kinematically related element, is associated with at least one angular position detector; and further comprising:
determining the cited longitudinal positions of the respective first, second and further marks within said printing length from readings of respective angular position signals coming from said angular position detector at the times of detecting a front edge, constituted either by said transversal edge or said oblique edge, of each of the respective first, second and further marks by the optical sensor; and
determining the cited transversal positions of the respective first, second and further marks within said printing length from a difference between readings of angular position signals coming from the angular position detector at the times of detecting the transversal and oblique edges, respectively, or vice versa, of each of the respective first, second and further marks by the optical sensor.

7. A method in accordance with claim 3, wherein the first, second and further marks are printed in a side margin of the material to be printed, free from a main print motif.

8. A method in accordance with claim 4, wherein the first printing roller is maintained rotating at a printing rotating speed when placed at said inactive position after having detected the longitudinal and transversal positions of the first mark printed by the same within the printing length.

9. A method in accordance with claim 2, wherein the first printing group is placed in a position that is more downstream than the second printing group and further printing groups.

10. A method in accordance with claim 2, wherein said optical sensor is a chromatic optical sensor.

11. A flexographic printer with a various colours printing register device, the printer comprising:
at least one rotating supporting drum, which supports the material to be printed,
at least first and second printing groups which include respective printing rollers with the same known printing length, with said first and second printing groups configured, arranged and selectively driven to change between a printing position, in which said first and/or second printing roller is in contact with said material to be printed on the cited supporting drum, and an inactive position, in which the first and/or second printing roller is separated from the material to be printed, being the first and second printing rollers driven by at least one driving group regulated by at least one controller; and
an optical sensor placed downstream from the first and second printing groups and arranged to detect at least first and second separated marks, respectively and consecutively printed by the first and second printing rollers on the material to be printed; with said controllers adapted and connected to:
receive from said optical sensor first and second position signals representative of the longitudinal and transversal positions of the respective first and/or second marks within said printing length; and one of:
generate first and second adjustment signals in function of a comparison of each of said first and second position signals with a pre-established position signal, said at least one driving group adjusting, based on said first and second adjustment signals, the angular and axial positions of the first and second printing rollers; or
generate an adjustment signal in function of a comparison of the second position signal with the first position signal, which is taken as reference, said at least one driving group adjusting, based on said adjustment signal, the angular and axial positions of the second printing roller (6) in accordance with the detected longitudinal and transversal positions of the first mark within the printing length.

12. A printer in accordance with claim 11, wherein it includes further printing groups placed upstream from said optical sensor configured, arranged and selectively driven in order to change between said printing and inactive positions, with said further printing groups having respective printing rollers with the cited known printing length, driven by at least one driving group controlled by the cited at least one controller, being said controller adapted and connected also to:
receive from said optical sensor further position signals that are representative of the longitudinal and transversal positions of the respective further marks within the printing length; and on of:
generate further adjustment signals in function of a comparison of each of said further position signals with a pre-established position signal, said at least one driving group adjusting, based on said further adjustment signals, the angular and axial positions of the further printing rollers; or
generate further adjustment signals in function of a comparison of the further position signals with the first position signal, which is taken as reference, said at least one driving group adjusting, based on said further adjusting signals, the angular and axial positions of the further printing rollers in accordance with the detected longitudinal and transversal positions of the first mark within the printing length.

13. A printer in accordance with claim 12, wherein the first, second and further marks have a triangular shape and comprise a transversal edge that is perpendicular to a longitudinal lateral edge of the material to be printed, a longitudinal edge parallel to said lateral longitudinal edge of the material to be printed and an oblique edge, and the optical sensor is arranged to consecutively detect the positions of the transversal and oblique edges, or vice versa, of the respective first, second and further marks when the material to be printed is moved under the same.

14. A printer in accordance with claim 13, wherein the first, second and further printing rollers comprise corresponding engraving configurations arranged to print said first, second and further marks, in a side margin of the material to be printed, free from a main print motif.

15. A printer in accordance with claim 12, wherein the first and second printing rollers, or first, second and further printing rollers are driven by respective first and second driving groups or first, second and further driving groups and are associated with respective first and second angular position detectors or first, second and further angular position detectors.

16. A printer in accordance with claim 12, wherein the first and second printing rollers, or first, second and further printing rollers are driven by respective first and second driving groups or first, second and further driving groups driven by an angular position control signal with respect to time that is common to all of them, or set point signal.

17. A printer in accordance with claim 12, wherein the supporting drum and the first and second printing rollers or the supporting drum and the first, second and further printing rollers are rotationally driven by a single common driving group, and the supporting drum is associated with at least one angular position detector.

18. A printer in accordance with claim 15, wherein the first printing roller is driven to rotate at a printing rotating speed while the first printing group is placed at the inactive position and said comparison of the second position signal or second and further position signals with the first position signal is performed.

19. A printer in accordance with claim 12, wherein said optical sensor is a chromatic optical sensor.

20. A printer in accordance with claim 12, characterised in that the first printing group is placed in a position that is more downstream than the second printing group and further printing groups.

21. A printer in accordance with claim 11, wherein the optical sensor is placed to scan a lateral margin of the material to be printed, while the material to be printed is on the supporting drum and moves along with it in order to detect the first and second marks.

22. A printer in accordance with claim 15, wherein each of the first and second driving groups or first, second and further driving groups include at least one rotating driving motor to rotate the corresponding printing roller and at least one linear driving motor to linearly move the corresponding printing roller in the axial direction.

23. A printer in accordance with claim 22, wherein at least one angular position detector is associated with said linear driving motor.
